(19) United States
(12) Patent Application Publication
(10) Pub. No.: US 2025/0170991 A1
(43) Pub. Date: May 29, 2025

(54) COLLAPSIBLE SNOW PADDLE AND METHOD OF USE

(71) Applicants: Stephen Patrick Wood, Tahoe City, CA (US); Lorraine Lee Wood, Tahoe City, CA (US)

(72) Inventors: Stephen Patrick Wood, Tahoe City, CA (US); Lorraine Lee Wood, Tahoe City, CA (US)

(21) Appl. No.: 19/036,924

(22) Filed: Jan. 24, 2025

Related U.S. Application Data
(63) Continuation of application No. 17/932,511, filed on Sep. 15, 2022, now abandoned.
Application No. 17/932,511 is a continuation of application No. 16/813,102, filed on Mar. 9, 2020, now abandoned.
Application No. 16/813,102 is a continuation of application No. 16/434,087, filed on Jun. 6, 2019, now Pat. No. 10,640,093.
(60) Provisional application No. 62/681,591, filed on Jun. 6, 2018.

(51) Int. Cl. B60S 3/04; B25G 1/10

(52) U.S. Cl. CPC B60S 3/045; B25G 1/102

(57) ABSTRACT

A collapsible snow paddle. The paddle includes an elongated handle, a rotatable coupling affixed to one end of the handle, and a generally planar snow remover, the rotatable coupling affixed to a rear surface of the remover so that he remover may be collapsed against the handle for storage and extended transverse to the handle for use. The snow remover may have a scraper edge inclined at an angle relative to the surface of the snow remover for scraping ice and a relatively soft capped edge for removing snow.

### CROSS-REFERENCE TO RELATED APPLICATION

This application is a continuation of Applicants' U.S. patent application entitled “Collapsible Snow Paddle And Method Of Use,” Ser. No. 17/932,511, filed Sep. 15, 2022, which claims priority through Applicants' prior U.S. patent application entitled “Collapsible Snow Paddle And Method Of Use,” Ser. No. 16/813,102, filed Mar. 9, 2020, which claims priority through Applicants' prior U.S. patent application entitled “Collapsible Snow Paddle And Method Of Use,” Ser. No. 16/434,087, filed Jun. 6, 2019, which claims priority through Applicants' prior U.S. Provisional Patent Application entitled “Collapsible Snow Paddle And Method Of Use,” Ser. No. 62/681,591, filed Jun. 6, 2018, all of which prior applications are hereby incorporated by reference in their entirety. It is to be understood, however, that in the event of any inconsistency between this specification and any information incorporated by reference in this specification, this specification shall govern.

### FIELD OF TECHNOLOGY

This application relates to a collapsible snow paddle and method of use, particularly in removing snow or ice from a vehicle.

### BRIEF ASPECTS OF THE BACKGROUND OF THIS SPECIFICATION

Snow removal from cars, trucks, and other vehicles has long presented a challenge. The challenge has long been particularly great when the accumulation of snow on the vehicle is substantial.

For example, in order to remove ice from a large vehicle front or rear window with an ice scraper, it can be difficult to reach the center area of the window unless the scraper is mounted to a long handle. Such scrapers exist but their typically fixed length consumes substantial space when stored in the vehicle such as on a rear seat or on the floor adjacent the rear seat.

Some such scrapers have long included a snow brush mounted on the handle for brushing snow off the vehicle. The snow brush bristles are typically quite flexible in order to prevent the bristles from scratching the vehicle's outer surfaces when used to remove snow from them. The snow brush is therefore typically easily bent, including by resistance presented by snow on the vehicle. As a result, removing snow from the vehicle with the brush can be difficult and time consuming, especially if the snow is deep or wet and heavy.

When snow is deep or wet and heavy, one common snow removal technique has been to use a conventional fixed-length snow shovel or a smaller, collapsible snow shovel. Conventional fixed-length show shovels are bulky and consume substantial storage space in the vehicle. Many vehicles are too small for such shovels. Smaller, collapsible snow shovels consume less space and are storable in most cars and trucks. Such shovels commonly have a collapsible handle, a shovel extending from one end of the handle, and a T-shaped grip extending transversely from the opposite end of the handle. They have been made of a variety of materials, such as aluminum or plastic.

These types of collapsible snow shovels are still somewhat bulky due to the rigid shovel extending from one end of the collapsible handle. They have not included an integral window scraper, and they have required a somewhat horizontal snow shoveling technique which can be difficult to employ when snow is in difficult-to-reach areas such as on the roof of the car or in a truck bed.

The Rapala Folding Pack Shovel with Bag has a foldable handle that can be folded and rotated with respect to the shovel to abut the shovel. This product can be stored in its accompanying bag. When extended, the handle is short and only approximately 13-15 inches long. Thus, this product is difficult to use for snow removal, especially on larger vehicles. It also does not include an ice scraper suitable for use on vehicle windows. When collapsed, the handle bends to fold upon itself and then rotates to abut the shovel end, providing a relatively thick, space-consuming folded shovel.

### BRIEF SUMMARY OF CERTAIN ASPECTS OF THIS SPECIFICATION

The inventors believe they have discovered at least some of the issues—and the severity of those issues—identified in the Background section above. The inventors have therefore invented a collapsible snow shovel, or paddle, providing an apparatus with a paddle (shovel) end opposite a window-scraper end.

In some embodiments, a collapsible handle is rotatably mounted to a paddle. In some instances a rotatable mount is disposed on a back surface of the paddle intermediate the opposed paddle end and window-scraper end of the handle.

Some applications provide a handle that telescopes from a collapsed position to an extended position and vice versa. At least some such applications can thus provide a snow paddle with a relatively short handle when fully collapsed for storage while also providing a snow paddle with a relatively long handle when extended for use. Some embodiments provide a handle with three or more telescoping sections so that the handle can be adjusted to provide any of several differing handle lengths during use.

Some embodiments include a handle grip at the end of the handle opposite the paddle. The handle grip can extend transverse to a longitudinal axis of the handle.

Some applications include a hand grip tube mounted about the thickest of the telescope sections.

The collapsible handle can have an elliptical or oblong cross-section with opposed widened sides extending generally parallel to the longitudinal axis of the handle. Some such applications can provide greater torsional stability for the handle.

In some embodiments the snow paddle may have a substantially planar paddle surface. The paddle may be rotatable about the paddle mount on the handle from a fully extended open position generally transverse to the longitudinal axis of the handle to a fully closed position with its planar surface generally parallel to and abutting the handle. The paddle may include a relatively soft snow shovel cap along one edge.

In the fully extended or open position, the snow paddle can be used to push or pull snow off of a surface such as a vehicle surface. For example, in some embodiments the user can grip the handle with one or two hands to push or pull the paddle and thereby push or pull snow with either surface of the paddle. In some embodiments, the user can alternatively use a scraper edge opposite the snow shovel cap to scrape snow or ice off of a surface. In some instances the user may position the scraper edge into snow on a surface and simultaneously use the scraper edge to scrape the surface and the paddle surface to push or pull snow off of the surface.

Some applications can allow the user to use the snow paddle with the handle telescoped to its minimum length and then grip the telescoped handle and scape snow or ice off of a surface with the paddle in either its collapsed or open position.

Embodiments can provide any or all of the features described above embodied in a unitary, light weight, and durable snow paddle and scraper that may be quite compact when telescoped and collapsed. Some embodiments can be small enough to store under a vehicle seat or in some other relatively small space in the vehicle.

There are other novel features and advantages of the disclosure of this specification. They will become apparent as this specification proceeds. In this regard, it is to be understood that the scope of the invention is to be determined by the claims as issued and not by whether it addresses an issue because it is set forth in the Brief Background or provides a feature because it is set forth in this Brief Summary.

### BRIEF DESCRIPTION OF THE DRAWINGS

The preferred and other embodiments are disclosed in association with the accompanying Figures in which:

FIG. 1 is a perspective view of an embodiment of a fully extended collapsible snow paddle and ice scraper;

FIG. 2 is a plan view of a variant the snow paddle and ice scraper of FIG. 1;

FIG. 3 is an elevational view of the snow paddle and ice scraper of FIG. 2;

FIG. 4 is a bottom view of the snow paddle and ice scraper of FIG. 2;

FIG. 5 is a side view of the paddle end of the snow paddle and ice scraper of FIG. 2;

FIG. 6 is a side view of the handle end of the snow paddle and ice scraper of FIG. 2;

FIG. 7 is a plan view of the snow paddle and ice scraper of FIG. 2 in its fully collapsed position;

FIG. 8 is an elevational view of the fully collapsed snow paddle and ice scraper of FIG. 7;

FIG. 9 is a bottom view of the fully collapsed snow paddle and ice scraper of FIG. 7;

FIG. 10 is a side view of the paddle end of the fully collapsed snow paddle and ice scraper of FIG. 7;

FIG. 11 is a side view of the handle end of the fully collapsed snow paddle and ice scraper of FIG. 7;

FIG. 12 is a plan view of a snow-paddle bag in which the collapsed snow paddle can be easily inserted through a narrower top end of the bag, also having a handle, and then stored and transported;

FIG. 13 is a section view of an embodiment of the handle taken along the line X-X in FIG. 7;

FIG. 14 is a plan view of an alternative, wider snow-paddle bag with the snow paddle inserted in the closed bag through an upper wider opening (not shown in FIG. 14) and having a shoulder strap for easy carrying of the paddle within the bag; and

FIG. 15 is a plan view of the snow paddle bag of FIG. 14 but with the upper, wider end open and snow paddle partially inserted in the paddle bag.

### DETAILED DESCRIPTION

This Detailed Description describes some embodiments but is not limiting of the scope of the invention. Further, components of these embodiments may be mixed and matched in differing permutations and combinations.

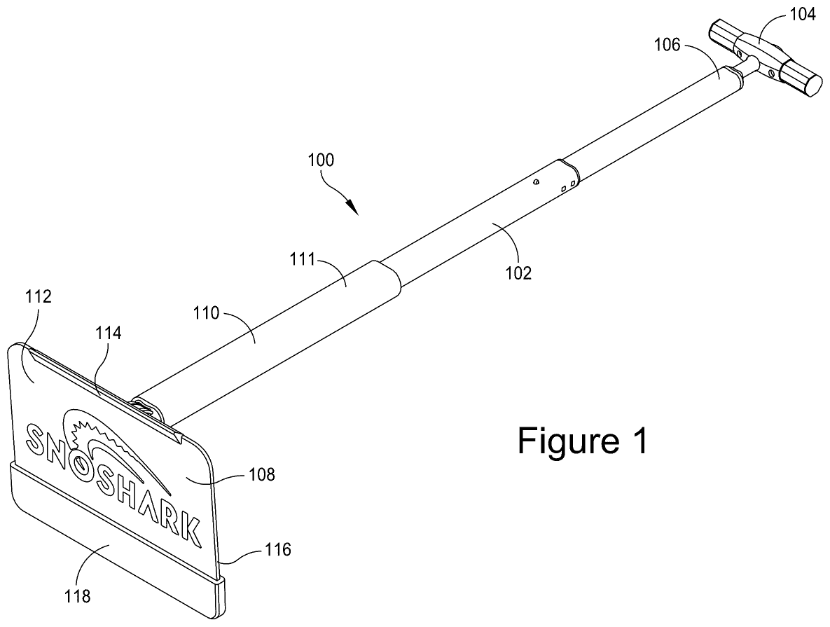

With reference now to FIG. 1, a fully extended, collapsible snow paddle, generally 100, has a telescoping handle 102 with a handle grip 104 at the handle's narrow end 106 and a snow paddle/scraper 108 at the handle's thickest, enlarged end 110. The handle grip 104 is transverse to a laterally-extending axis of the telescoping handle 102, and, in the extended, open position of FIG. 1, the snow paddle/scraper 108 is also generally transverse to the laterally-extending axis of the telescoping handle 102. A relatively soft, flexible, and resilient foam tube 111 is mounted about the handle's thickest, enlarged end 110 so that a user can grip the handle grip 104 with one hand and the enlarged end 110 through the foam tube 111 with the other hand.

The snow paddle/scraper 108 has a planar, somewhat rectangular, rigid central snow-removal paddle 112 with a laterally extending ice scraper edge 114 opposite a laterally extending lower edge 116. A relatively softer (as compared to the central snow removal paddle 112 and ice scraper edge 114), flexible, laterally extending, and resilient plastic lower edge cap 118 is mounted to surround the lower edge 116 of the central snow paddle 112 in order to prevent the lower edge 116 from scratching vehicle surfaces such as painted metal, windows, and seals.

The edge cap 118 is removable from, and replaceable on, the lower edge 116 central snow removal paddle 112. Thus, the edge cap 118 can be easily replaced as it becomes damaged or worn down, which can economically extend the usability of the remaining components of the paddle 100 as well as provide further revenue for a business directed to selling the snow paddle 100 and its replaceable edge cap 118.

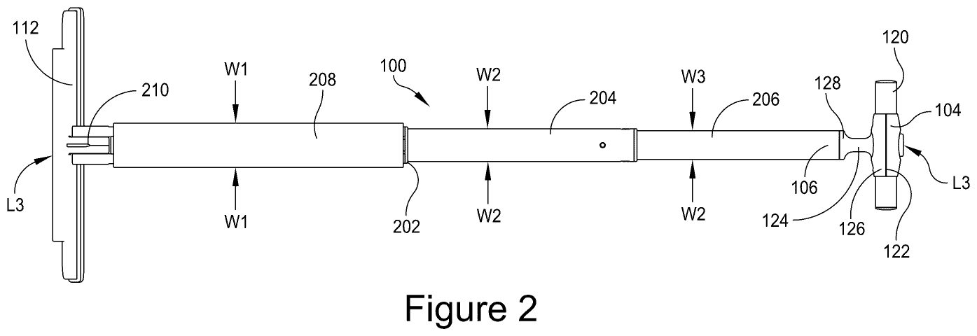

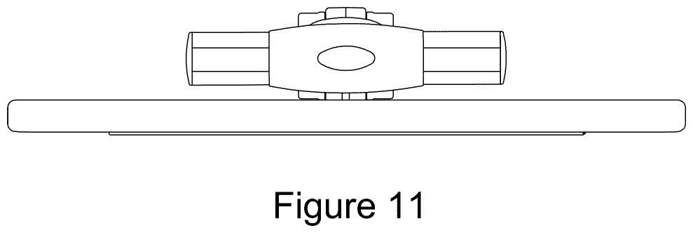

FIGS. 2-11 depict the basic snow paddle 100 of FIG. 1 with yet additional structure, such as an additional, outwardly and laterally extending sharpened but relatively thin scraper edge 114. In some embodiments, the scraper edge 114 is made of material more rigid than that of a relatively more flexible and soft central snow-removal paddle 112.

With reference now to FIG. 2, the handle grip 104 has a central. laterally extending tubular section 120 mounted within a T-shaped rigid plastic grip/mount 122. An I-component 124 of the T-shaped mount 122 is narrowed with respect to its transverse component 126 surrounding the central tubular section 120. The lower end 128 of the I-component 124 is securely mounted within, and penetrates, the telescoping handle's narrow end 106.

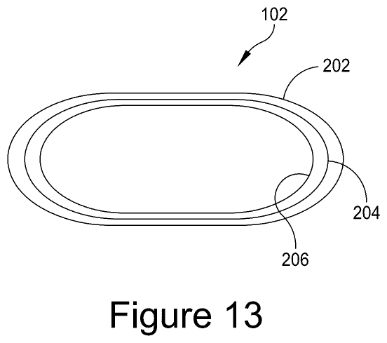

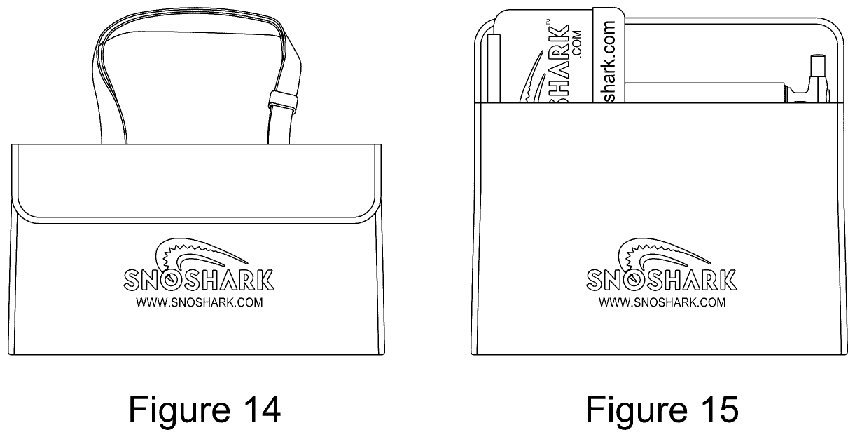

With reference now to FIGS. 2, 3 and 13, in some embodiments the three telescoping handle tubes 202, 204, and 206 have an oblong, tubular cross-section and an oblong, tubular, flexible, compressible, resilient foam grip 208 surrounds the widest handle tube 202 adjacent a rotatable paddle mount 210 to which the paddle 112 is mounted. The widths W1-W1, W2-W2, and W3-W3 of the three telescoping handle sections 202, 204, and 206, respectively, are substantially greater than their respective depths D1-D1, D2-D2, and D3-D3. In one embodiment, the widths and depths are as follows: W1-W1, W2-W2, and W3-W3 are 1.5, 1.3, and 1.2 inches, respectively, and D1-D1, D2-D2, and D3-D3 are 1.0, 0.8, and 0.6 inches, respectively; and the thickness of the foam grip 208 is 0.3 inches. The tubular walls of the telescoping handle sections 202, 204, 206 are approximately 0.018 inches thick.

The telescoping handle 102 could have more than 3 telescoping sections to provide, for example, greater reach in some applications; or the telescoping handle could have fewer than three sections. The handle could be other than tubular in cross-section, such as square for example. The handle sections may all be of the same length or they may be of differing lengths as desired. In some embodiments the handle 102 may consist of only one section.

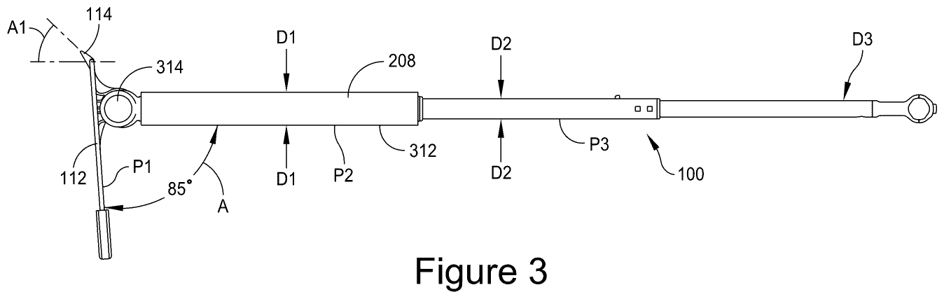

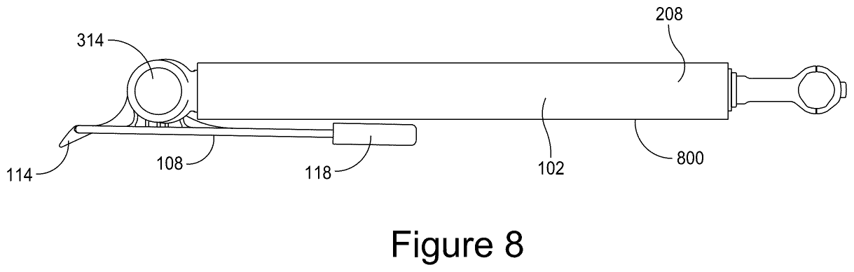

Referring now to FIG. 3, when the snow paddle 100 is in the fully opened position, a plane P1 of the paddle 112 is parallel to the axis of the handle grip 104 and defines an angle A of about 86 degrees to a plane P2 of the lowermost side 312 of the foam grip 208. The scraper edge 114 extends from the central paddle 112 at an angle A1 of approximately 45 degrees from the plane P1 of the paddle 112. This angle A1 could vary from 0 degrees to 170 degrees; and angle A may also vary by up to about plus or minus 30 degrees. As shown in FIG. 8, the scraper edge 114 may have a generally triangular cross-section with a somewhat rounded scraping edge 115 on its distal end 115 opposite its wider end 117 integrally formed on, or otherwise secured to, the central paddle 112.

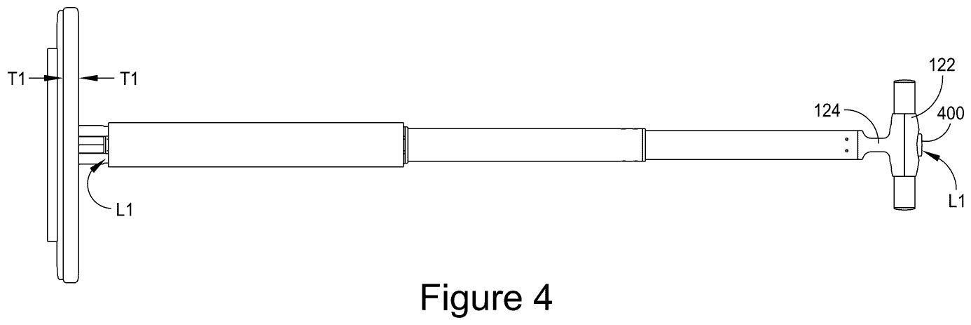

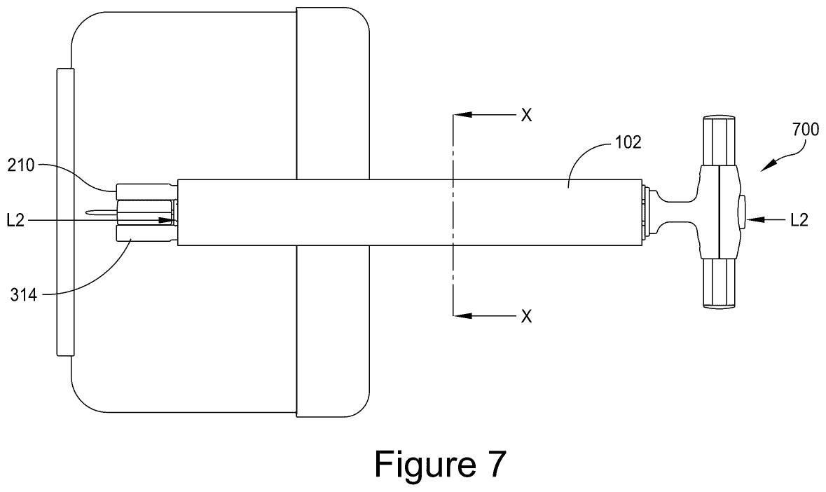

With reference to FIG. 4, the lateral length of the fully extendable telescoping handle L1-L1 is about 37.5 inches. A spring biased, handle collapsing button 400 extends laterally outwardly coaxial with the central axis of the I-component 124 of the T-shaped grip/mount 122. Pressing this button 400 and pushing of the handle grip 104 causes internal collapsing structure (not shown) to fully collapse the telescoping handle 102 so that, as shown in FIG. 7, the length L2-L2 of the telescoping handle is shortened to 17 inches. The internal collapsing structure is of the same type used to collapse telescoping luggage handles.

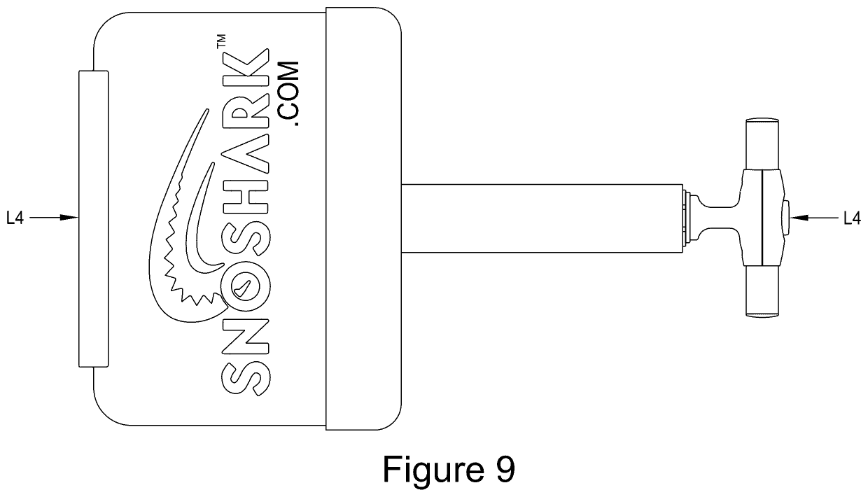

With reference back to FIG. 2, the overall lateral length of the fully extended and opened snow paddle L3-L3 is 37 inches. With contrasting reference to FIG. 9, the overall lateral length of the fully collapsed and closed snow paddle L4-L4 is 20 inches.

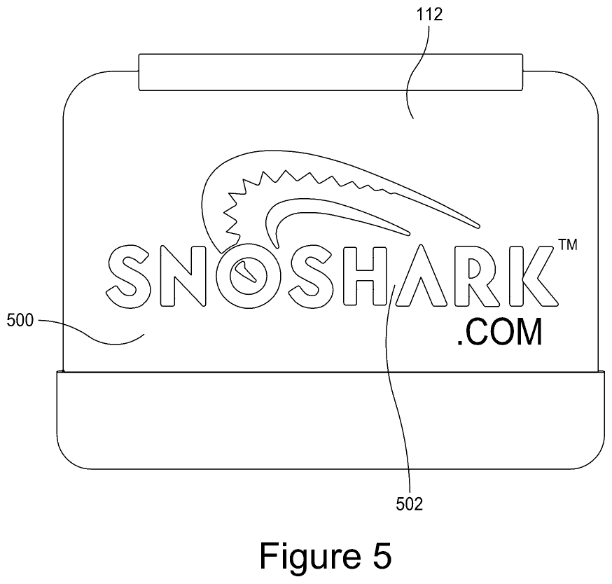

Referring now to FIG. 5, the outer surface 500 of the central paddle 112 can include indicia 502 such as trade identify information for example. The indicia 502 may be formed on the central paddle 112 in any suitable way, such as, for example, by painting on, or laser cutting into, the outer surface 500. The central paddle 112 may also have rounded peripheral corners 504, 506, 508, 509 to prevent damaging a surface (including human skin) with which they may come into contact during use or when stored or other non-use.

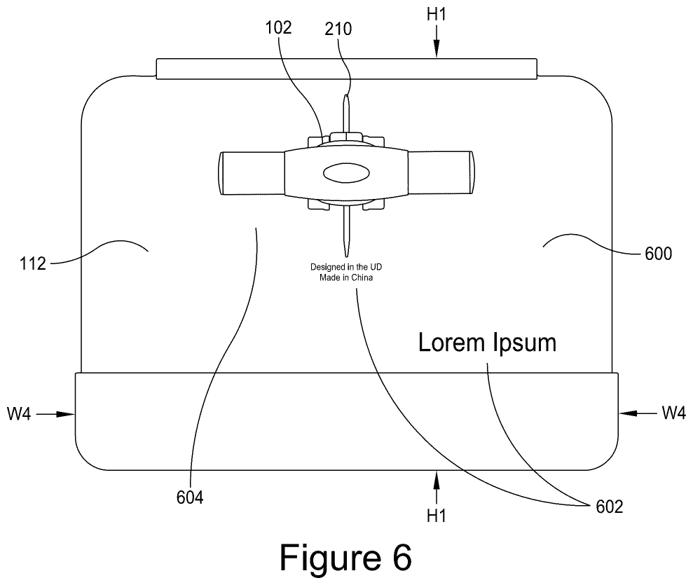

Referring now to FIG. 6, the inner surface 600 of the central paddle 112 can also include indicia 602 formed in any suitable way. The paddle mount 210 can be mounted closer to the scraper edge 114 than the lower edge 116 surrounded by the edge cap 118, providing a substantially larger paddle surface area 604 below the paddle mount 210 and the telescoping handle 102 extending from the paddle mount 210. The paddle's inner surface 600 can therefore be used to pull material, such as snow, off pf a surface; and, with contrasting reference to FIG. 5, the paddle's outer surface 500 can be used to push material off of a surface.

The paddle's height H1-H1 can be about 8 inches and its width W4-W4 can be about 11 inches or 28.59 cm. The thickness of the edge cap material can be approximately 0.25 inches. With reference back to FIG. 4, the thickness T1-T1 of the central paddle 112 can be approximately ⅛th of an inch, for example.

With reference to FIGS. 3, 4, and 7, by collapsing the telescoping handle 102 as described above and then pressing and depressing a spring-biased paddle rotation button 314 within a tubular button housing 316 with its axis extending (i) transverse to the axis of the handle 102 within the paddle mount 210 and (ii) parallel to the axis of the handle grip 104, the snow shovel 700 fully collapses to a collapsed position as shown in FIGS. 7-11. With reference to FIG. 8, in the fully collapsed position, the snow paddle/scraper 108 has been rotated and locked so that the edge cap 118 securely abuts the lowermost underside 800 of the foam grip 208 and the collapsed telescoping handle 102 is securely locked in the collapsed state. In one embodiment, the edge cap has a thickness ET of 1.17 cm, a height EH of 5.7 cm, a weight of 66.5 g, and a durometer shore 00 rating of 30 to 80, for example 65; and the snow removal paddle 112 has a durometer shore A rating of from 55-100, for example 80.

In the fully collapsed position, the scraper edge 114 of the snow paddle 100 can be used as an ice scraper. Alternatively, when in the fully collapsed position, pressing the paddle rotation button 314 can allow the user to rotate the paddle/scraper to its fully extended and opened position (not shown in FIG. 8) and use this arrangement of the snow paddle either as a shortened snow-removal paddle or snow or ice scraper.

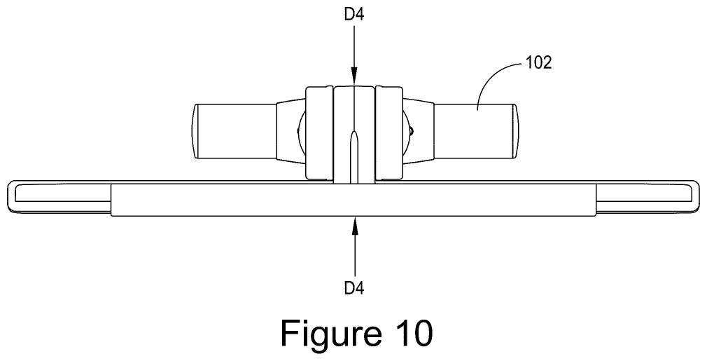

With reference now to FIG. 10, the depth D4-D4 of the collapsed snow paddle 102 is approximately 1 and ⅝th inches. The relatively small volume and size of this embodiment of the collapsed snow paddle 102 frequently can be stored under a vehicle seat, behind a seat, on a vehicle floor, or in a utility container or drawer such as on the back of a truck.

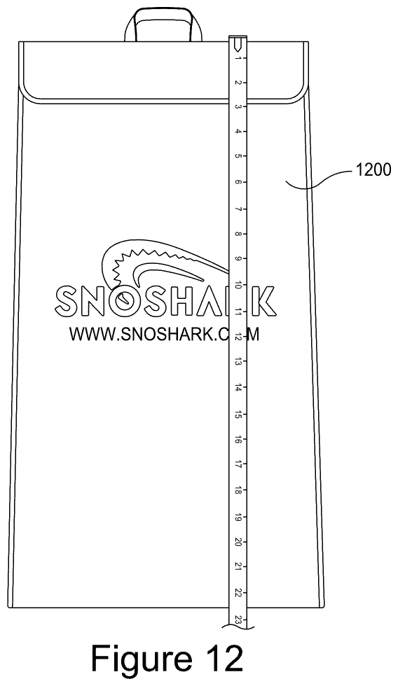

With reference now to FIG. 12, the snow paddle when collapsed can be attractively stored in a snow paddle bag such as the bag 1200 shown in FIG. 12. One embodiment of this bag 1200 can be approximately 22-23 inches high by 12-13 inches wide. The external periphery of the snow paddle bag can also include indicia, such as trademark(s), web site url, and other information as desired.

With reference back to FIGS. 2-4, the following components may be made with the following materials:
telescoping tubes 202, 204, 206: metal such as aluminum;
central paddle 112: rigid plastic, such as HDPE, nylon, or polypropylene;
scraper edge 114: rigid plastic, such as HDPE, nylon, or polypropylene;
edge cap 118: relatively soft and stretchable plastic such as EVA or polyethylene;
rotation button 314: a rigid plastic, such as HDPE, nylon, or polypropylene;
tubular button housing: zinc alloy;
paddle mount 210: a rigid plastic, such as HDPE, nylon, or polypropylene;
handle grip tubular section 120: 0.2 inch thick aluminum of;
T-shaped mount 122: rigid plastic, such as HDPE, nylon, or polypropylene;
snow paddle bag: any suitable fabric, such as polyester or polypropylene; and
foam grip 208: plastic foam, such as molded polyethylene foam or PP/TPE or EVA.

One of more of the plastic components above may also include anti-freeze mixed within it or coated on the outer surface. In one embodiment, at least the foam grip 208, paddle mount 210, and T-shaped mount include such anti-freeze.

The entire collapsed snow paddle of FIGS. 7-11 weighs approximately 0.5 to 2 lbs. In the depicted embodiment it may weigh about 0.5-0.75 lb. The snow paddle bag 1200 of FIG. 12 weighs about 7 ounces. The collapsed snow paddle and bag are thus not only compact but also light weight and economical to ship, store, and transport.

An alternative embodiment of the snow paddle (not shown) may be substantially larger than the snow paddle of FIGS. 1-11, such as for use with large vehicles like trucks and large SUVs. For example, such a snow paddle may weigh 2.5 lbs. and have a fully extended length, from snow paddle to the opposed handle, of 54 inches and a fully collapsed length, of 24 inches.

One method of use of the snow paddle and bag is as follows:
remove the snow paddle from its place of storage and bag;
extend the telescopic handle if desired;
press the paddle rotation to rotate the paddle to the extended and fully open position;
if desired, hold the foam grip with one or two hands to scrape ice on a surface with the scraper edge;
if desired, grasp the handle grip with one hand and the telescoping handle with the other hand and insert opened paddle into snow on a surface and push or pull the telescoping handle and paddle to push snow away or pull it off the surface (note that the depicted size of the rigid paddle can push or pull relatively large quantities of snow; larger paddles can push or pull yet larger quantities; also note that the paddle scraper edge can be inserted into snow to both scrape with the scraper edge and remove push or pull snow at the same time);
fully collapse and close the snow paddle; and
place the snow paddle in its storage bag and store the paddle and bag as desired.
   Yet other variations for use of the snow paddle are set forth above, and they may be mixed and matched with steps set forth in the preceding sentence in this paragraph.

Embodiments of the snow paddle can also be used to: remove debris from vehicles, decks, railings, and other structures; remove snow from the area around a vehicle; and quickly remove snow from tree wells to rescue snow boarders, skiers, etc.

Further, components of the snow paddle may be replaceable. For example, the scraper edge and the edge cap may be sized and formed to be replaceable on the paddle. Similarly, the foam grip may be removable and replaceable on the thickest telescoping tube section.

The process parameters, functions, system features, and sequence of steps described and/or illustrated herein are given by way of example only and may be varied and mixed and matched as desired. The various exemplary methods described and/or illustrated herein may also omit one or more of the steps described or illustrated herein or include additional steps in addition to those disclosed.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Unless otherwise indicated, all numbers or expressions, such as those expressing dimensions, physical characteristics, and the like, used in the specification (other than the claims) are understood to be alternately modified in all instances by the term “approximately.” At the very least, and not as an attempt to limit the application of the doctrine of equivalents to the claims, each numerical parameter recited in the specification or claims which alternately modified by the term “approximately” should at least be construed in light of the number of recited significant digits and by applying ordinary rounding techniques.

All dimensions herein or in the Figures can be varied for varying circumstances, uses, and objects. They may be varied by ranges of plus or minus 0.01% through up to 1000% or even higher—also with the ranges in some embodiments varying by differing amounts for differing components.

As used in this specification, the term “laterally extending” means along a length of a referenced component that is at least fifty percent longer than the width of the component.

A statement of a numerical range includes a sub-statement all possible sub-ranges within the stated range.

We claim:

1. A collapsible snow paddle comprising:
an elongated collapsible handle;
a rotatable coupling affixed to a proximal extremity of the handle; and
a rigid, substantially planar snow removal paddle, the rotatable coupling affixed to a rear surface of the snow removal paddle whereby the snow removal paddle may be collapsed against the handle for storage and extended at an angle away from the handle for use.

2. The snow paddle of claim 1 and further comprising a handgrip affixed to a distal extremity of the handle.

3. The snow paddle of claim 2 wherein the handgrip is oriented approximately transverse to the handle to define therewith a T shape.

4. The snow paddle of claim 1 and further comprising a hand grip tube disposed on the handle intermediate the proximal and distal extremities.

5. The snow paddle of claim 1 wherein at least a portion of the handle has an oblong-shaped cross section.

6. The snow paddle of claim 1 wherein the dimensions of the snow remover are about 8 inches by 11 inches.

7. The snow paddle of claim 1 wherein the handle comprises a plurality of telescoping sections.

8. The snow paddle of claim 7 wherein the handle comprises three telescoping sections.

9. The snow paddle of claim 7 wherein the handle when telescoped is about 20 inches in length and when extended is about 39 inches in length.

10. The snow paddle of claim 1 wherein an edge of a front surface of the snow remover is inclined to define a scraper edge, the scraper edge forming an acute angle with a longitudinal axis of the handle when the paddle is extended.

11. The snow paddle of claim 10 wherein the rotatable coupling is affixed to the rear surface of the snow remover at a location offset from center toward the scraper edge.

12. The snow paddle of claim 10 wherein a shovel edge of the front surface of the snow remover opposite the scraper edge is relatively softer than the scraper edge.

13. The snow paddle of claim 1 and further comprising a shovel cap disposed along an edge of the snow remover, the cap being relatively softer than the snow remover.

14. The snow paddle of claim 1 and further comprising a snow paddle bag having a carrying handle and an opening sized to receive the snow paddle when collapsed.

15. A method of removing snow from a vehicle comprising:
removing from storage a snow paddle;
rotating a snow remover of the snow paddle into a transverse orientation relative to a handle of the snow paddle;
using a scraping edge of the snow remover to remove ice from a window of the vehicle;
using a capped edge of the snow remover to remove snow from the vehicle by pushing and pulling motions;
rotating the snow remover into a parallel orientation with the handle; and
replacing the snow paddle in storage.

16. The method of claim 15 and further comprising extending the handle prior to using, and telescoping the handle prior to replacing the snow paddle in storage.

17. The method of claim 15 wherein removing the snow paddle from storage comprises removing it from a snow paddle bag.
